(19) United States
(12) Patent Application Publication
(10) Pub. No.: US 2019/0086729 A1
(43) Pub. Date: Mar. 21, 2019

(54) LIGHT GUIDE MEMBER, BACKLIGHT UNIT, AND LIQUID CRYSTAL DISPLAY DEVICE

(71) Applicant: FUJIFILM CORPORATION, Tokyo (JP)

(72) Inventors: Yukito SAITO, Kanagawa (JP); Kotaro YASUDA, Kanagawa (JP); Shinya WATANABE, Kanagawa (JP)

(21) Appl. No.: 16/194,393

(22) Filed: Nov. 19, 2018

Related U.S. Application Data
(63) Continuation of application No. PCT/JP2017/018938, filed on May 19, 2017.

(30) Foreign Application Priority Data
May 20, 2016 (JP) 2016-101750
Aug. 31, 2016 (JP) 2016-170318

(51) Int. Cl. G02F 1/1335; G02B 5/30; G02B 5/02; F21V 8/00

(52) U.S. Cl. CPC G02F 1/133606; G02F 1/133615; G02B 6/0051; G02B 5/3066; G02B 5/0278; G02F 1/13362

(57) ABSTRACT

A light guide member includes a light guide layer that guides incident light and emits the light from at least one main surface and a light transmission control layer that is integrally laminated on the light guide layer on a main surface side of the light guide layer that emits the light and controls a region that transmits light, and the light transmission control layer has a polarization conversion layer in which a polarization conversion portion is patterned, between two reflective polarizer layers and having different reflection polarization directions.

### CROSS-REFERENCE TO RELATED APPLICATIONS

This application is a continuation application of International Application No. PCT/JP2017/018938, filed May 19, 2017, the disclosure of which is incorporated herein by reference in its entirety. Further, this application claims priority from Japanese Patent Application No.2016-101750, filed May 20, 2016, and Japanese Patent Application No.2016-170318, filed Aug. 31, 2016, the disclosures of which are incorporated herein by reference in their entirety.

### BACKGROUND OF THE INVENTION

### 1. Field of the Invention

The present invention relates to a light guide member and a backlight unit used in a liquid crystal display device, and a liquid crystal display device using the light guide member and the backlight unit.

### 2. Description of the Related Art

A liquid crystal display device (hereinafter, also referred to as a liquid crystal display (LCD)) expands applications thereof as an image display device that has low power consumption and saves spaces. For example, the liquid crystal display device is formed by providing a backlight unit, a backlight side polarizing plate, a liquid crystal panel, a viewing side polarizing plate, and the like in this order.

As the backlight unit, a direct-type backlight unit in which a light source is arranged under an emitting surface and an edge light-type backlight unit in which a light source is arranged laterally to the emitting surface (also referred to as a side light type) are known.

In recent years, in order to be applicable to an electronic display device such as a television or a smart phone in which an image display surface is curved, a flexible backlight unit used for a liquid crystal display device having flexibility (bendability) has been developed (for example, JP2013-008446A).

### SUMMARY OF THE INVENTION

Many of the backlight units comprise a light guide member such as a light guide plate or a light guide film that guides light incident from the light source and emits the light from the entire main surface at substantially uniform brightness.

This light guide member is formed to propagate light over the entire area of the member while the light is totally reflected in the member, and eliminate the total reflection condition by causing the propagation direction of the light propagating in the light guide member in a light deflection portion such as a concavo-convex shape optically designed such that light is emitted with substantially uniform brightness from the entire main surface to come closer to the direction orthogonal to the main surface, such that the light is extracted.

However, in a case where the light guide member of the backlight unit is bent, there was concern that the total reflection condition in the light guide member collapses, light leaks from an unintended portion, and the uniformity of the brightness of the backlight and/or the front brightness decreases.

In view of the above circumstances, an object of the present invention is to provide a light guide member and a backlight unit which are used for the liquid crystal display device, and in which the decrease in the uniformity of the brightness of the backlight and/or the front brightness in a case of being bent is suppressed, and a liquid crystal display device using the light guide member and the backlight unit.

A light guide member according to the present invention comprises: a light guide layer that guides incident light and emits the light from at least one main surface; and a light transmission control layer that is integrally laminated on the light guide layer on a main surface side of the light guide layer that emits the light and controls a region that transmits the light, in which the light transmission control layer has a polarization conversion layer in which a polarization conversion material is patterned, between two reflective polarizer layers having different reflection polarization directions.

In the light guide member according to the present invention, the polarization conversion material may be a birefringent body or a depolarizer.

The reflective polarizer layer may be a birefringent polymer multilayer polarization film or a cholesteric liquid crystal.

A backlight unit of the present invention comprises a light guide member provided with an in-plane brightness homogenizing layer on the light transmission control layer of the light guide member according to the present invention; and a light source that causes light to be incident on the light guide member.

A liquid crystal display device according to the present invention comprises: a liquid crystal display element in which backlight is incident from a backlight incidence surface on an opposite side to an image display surface; and a backlight unit having the light guide member of the present invention and a light source that causes light to be incident on the light guide member, in which the liquid crystal display element and the light guide member are integrally laminated on each other, in a state in which the backlight incidence surface of the liquid crystal display element and the transmission control layer of the light guide member face each other, and a polarization axis direction in a case of incidence of backlight set in the liquid crystal display element and a polarization axis direction of light emitted from the light guide member coincide with each other.

Another liquid crystal display device according to the present invention comprises: a liquid crystal display element in which backlight is incident from a backlight incidence surface on an opposite side to an image display surface; and the backlight unit according to the present invention, in which the liquid crystal display element and the light guide member are integrally laminated on each other, in a state in which the backlight incidence surface of the liquid crystal display element and the light transmission control layer of the light guide member face each other, and a polarization axis direction in a case of incidence of backlight set in the liquid crystal display element and a polarization axis direction of light emitted from the light guide member coincide with each other.

The light guide member according to the embodiment of the present invention includes a light guide layer that guides incident light and emits the light from at least one main surface and a light transmission control layer that is integrally laminated on the light guide layer on the main surface side of the light guide layer that emits light and controls a region that transmits the light, and the light transmission control layer has a polarization conversion layer in which a polarization conversion material is patterned between two reflective polarizer layers having different reflection polarization directions. Therefore, in the backlight unit having this light guide member, it is possible to suppress the decrease in the uniformity of the brightness of the backlight and/or the front brightness in a case where the light guide member is bent.

In the backlight unit according to the embodiment of the present invention, since an in-plane brightness homogenizing layer is arranged on the light transmission control layer of the light guide member according to the embodiment of the present invention, it is possible to further enhance the uniformity of the brightness of backlight.

The liquid crystal display device according to the embodiment of the present invention has a liquid crystal display element in which backlight is incident from a backlight incidence surface on an opposite side to an image display surface; and a backlight unit having the light guide member according to the embodiment of the present invention and a light source that causes light to be incident on the light guide member, and the liquid crystal display element and the light guide member are integrally laminated in a state in which a backlight incidence surface of the liquid crystal display element and a light transmission control layer of the light guide member face each other, and a polarization axis direction in a case of incidence of the backlight set in the liquid crystal display element and a polarization axis direction of the light emitted from the light guide member coincide with each other. Therefore, it is possible to suppress the decrease in the uniformity of the brightness of the backlight and/or the front brightness in a case where the liquid crystal display device is bent. Since the light emitted from the light guide member already has polarizing properties, it is possible to omit a polarized light reflective-type brightness enhancement film and/or a polarizing plate which is generally provided between the liquid crystal display element and the backlight unit and which causes the light incident on the liquid crystal display element to be predetermined polarized light. Therefore, it is possible to contribute to thinning, weight reduction, and cost reduction.

Another liquid crystal display device according to the embodiment of the present invention has a liquid crystal display element in which backlight is incident from a backlight incidence surface on an opposite side to an image display surface; and the backlight unit according to the embodiment of the present invention, and the liquid crystal display element and the light guide member are integrally laminated in a state in which a backlight incidence surface of the liquid crystal display element and a light transmission control layer of the light guide member face each other, and a polarization axis direction in a case of incidence of the backlight set in the liquid crystal display element and a polarization axis direction of the light emitted from the light guide member coincide with each other. Therefore, it is possible to suppress the decrease in the uniformity of the brightness of the backlight and/or the front brightness occurring in a case where the liquid crystal display device is bent, further increase the uniformity of the brightness of the backlight, and contribute to thinning, weight reduction, and cost reduction.

### BRIEF DESCRIPTION OF THE DRAWINGS

FIG. 1 is a schematic cross-sectional view illustrating a schematic configuration of a liquid crystal display device according to a first embodiment of the present invention.

FIG. 2 is a schematic plan view illustrating an emitting surface side of a light guide member of the liquid crystal display device according to the first embodiment.

FIG. 3 is a schematic cross-sectional view illustrating a schematic configuration of the light guide member of the liquid crystal display device according to the first embodiment.

FIG. 4 is a schematic cross-sectional view illustrating a schematic configuration of the light guide member of the liquid crystal display device according to another embodiment of the present invention.

FIG. 5 is a view for describing a method of evaluating the light guide member according to the embodiment of the present invention (part 1).

FIG. 6 is a schematic cross-sectional view illustrating a schematic configuration of the liquid crystal display device according to a second embodiment of the present invention.

FIG. 7A is a schematic cross-sectional view illustrating an in-plane brightness homogenizing layer according to the second embodiment of the present invention (part 1).

FIG. 7B is a schematic cross-sectional view illustrating the in-plane brightness homogenizing layer according to the second embodiment of the present invention (part 2).

FIG. 7C is a schematic cross-sectional view illustrating the in-plane brightness homogenizing layer according to the second embodiment of the present invention (part 3).

FIG. 7D is a schematic cross-sectional view illustrating the in-plane brightness homogenizing layer according to the second embodiment of the present invention (part 4).

FIG. 7E is a schematic cross-sectional view illustrating the in-plane brightness homogenizing layer according to the second embodiment of the present invention (part 5).

FIG. 8 is a view illustrating an emitting surface side of the light guide member of the liquid crystal display device that shows arrangement of a polarization conversion portion according to the second embodiment.

FIG. 9 is a perspective view of the light guide member according to the second embodiment.

FIG. 10 is a schematic cross-sectional view illustrating a schematic configuration of the light guide member of the liquid crystal display device according to the second embodiment (part 1).

FIG. 11 is a schematic cross-sectional view illustrating a schematic configuration of the light guide member of the liquid crystal display device according to the second embodiment (part 2).

FIG. 12 is a view for describing a method of evaluating the light guide member according to the embodiment of the present invention (part 2).

### DESCRIPTION OF THE PREFERRED EMBODIMENTS

Hereinafter, embodiments of a liquid crystal display device according to the embodiment of the present invention will be described in detail with reference to the drawings.

According to the present specification, unless described otherwise, the numerical range expressed by using “to” means a range including numerical values described before and after “to” as a lower limit value and an upper limit value.

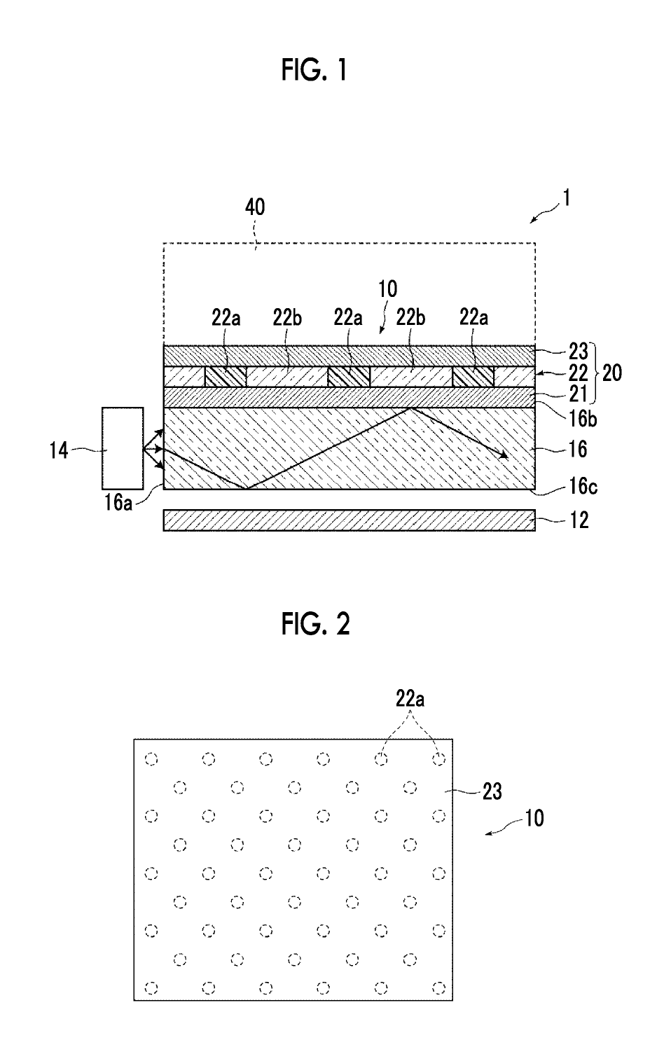

FIG. 1 is a schematic cross-sectional view illustrating a schematic configuration of a liquid crystal display device according to a first embodiment of the present invention, and FIG. 2 is a schematic plan view illustrating an emitting surface side of a light guide member 10 of the liquid crystal display device 1.

This liquid crystal display device 1 has a liquid crystal display element 40 in which backlight is incident from a backlight incidence surface on an opposite side to an image display surface; a backlight unit having the light guide member 10 and a light source 14 that causes light to be incident on an end face of the light guide member 10, and a reflection plate 12.

The light guide member 10 has a light guide layer 16 that guides incident light and emits the light from at least one main surface; and a light transmission control layer 20 that integrally laminated with the light guide layer 16 on a main surface side of the light guide layer 16 that emits light and controls a region that transmits the light. The light transmission control layer 20 has a polarization conversion layer 22 in which a polarization conversion portion 22a is patterned, between two reflective polarizer layers 21 and 23 having different reflection polarization directions.

The backlight incidence surface of the liquid crystal display element 40 and the light transmission control layer 20 of the light guide member 10 face each other, and the liquid crystal display element 40 is laminated on the light guide member 10 in a state in which a polarization axis direction in a case of the incidence of the backlight set in the liquid crystal display element 40 and a polarization axis direction of light emitted from the light guide member 10 coincide with each other.

As the light guide layer 16, various well-known plate-like materials (sheet-like materials) that propagate light incident from the end face in a planar direction can be used. The light guide layer 16 may be formed of a resin having high transparency as in a light guide plate used for a well-known backlight device, such as polyethylene terephthalate, polypropylene, polycarbonate, an acrylic resin such as polymethyl methacrylate, benzyl methacrylate, an MS resin (polymethacryl styrene), a cycloolefin polymer, a cycloolefin copolymer, and cellulose acylate such as cellulose diacetate and cellulose triacetate. A refractive index of the light guide layer 16 needs to be greater than that of the air.

With respect to the light transmission control layer 20, it is preferable to use the two reflective polarizer layers 21 and 23 having different reflection polarization directions in which the reflection polarization directions are shifted by λ/2, and for example, one reflective polarizer layer that transmits right-handed circularly polarized light and reflects the other polarized light and the other reflective polarizer layer that transmits left-handed circularly polarized light and reflects the other polarized light may be combined with each other. One reflective polarizer layer that transmits predetermined linearly polarized light and reflects the other polarized light and the other reflective polarizer layer that transmits linearly polarized light of which angle is inclined by an angle of 90° with respect to one reflective polarizer layer and reflects the other polarized light may be combined with each other. As the reflective polarizer layer, a well-known cholesteric liquid crystal that transmits circularly polarized light in a predetermined rotation direction may be used, or a well-known birefringent polymer multilayer polarization film that transmits linearly polarized light in a predetermined direction may be used. Specific examples of the configuration of these reflective polarizer layers 21 and 23 are provided in the following examples.

As the polarization conversion portion 22a in the polarization conversion layer 22, a well-known birefringent body may be used or a well-known depolarizer may be used. A non-polarization conversion portion 22b in the polarization conversion layer 22 is a member having no retardation and can be an air layer. Specific examples of the configuration of the polarization conversion layer 22 are provided in the following examples.

As the birefringent body, for example, a birefringent body obtained by aligning a rod-like or disk-like liquid crystal compound may be used. As the depolarizer, for example, a scatterer containing organic or inorganic particles can be used.

As illustrated in an example in FIG. 2, a formation pattern of the polarization conversion portion 22a in the polarization conversion layer 22 can be a pattern in which a plurality of circular regions of a predetermined size are provided at a predetermined pitch. In FIG. 2, the two-dimensional arrangement of the polarization conversion portion 22a is an arrangement in which even matrices and odd matrices are shifted from each other by a half pitch (so-called staggered arrangement), but the arrangement and the arrangement pitch of the polarization conversion portion 22a are not particularly limited. The arrangement of the polarization conversion portion 22a is not limited to the arrangement illustrated in FIG. 2, and may be a matrix arrangement (so-called lattice form arrangement) in which even matrices and odd matrices are matched or may be random. In order to make the brightness uniform in the emitting surface, the polarization conversion portion 22a may be arranged in an in-plane distribution considering the arrangement of the polarization conversion portion 22a and a distance from the light source 14. For example, the polarization conversion portion 22a may be formed such that the arrangement density of the polarization conversion portion 22a becomes higher as it goes away from the light source position, or the area of one of the polarization conversion portion 22a may be increased.

An area ratio (a proportion of a sum of the area of the plurality of polarization conversion portions 22a with respect to the total area of the light transmission control layer 20) of the polarization conversion portion 22a the polarization conversion layer 22 is preferably 10% to 50%. In a case where an area ratio of the polarization conversion portion 22a is 10% or more, it is possible to suppress a decrease in the amount of light transmitted from the light guide member 10. In a case where the area ratio is 50% or less, even in a case where the liquid crystal display element 40 on which the light guide member 10 is laminated is folded, it is possible to prevent the leakage of light from an unintended portion (a region where the polarization conversion portion 22a is not formed in the light transmission control layer 20) and the decrease in the uniformity of the brightness of the backlight and/or the front brightness.

The shape of the upper surface of the polarization conversion portion 22a is not limited to the circular shape as described above, and may be a rectangle or an irregular shape. The arrangement form is not limited to the above two-dimensional arrangement. For example, in the polarization conversion layer 22, it is also possible to form a stripe arrangement in which the rectangular polarization conversion portion 22a and the non-polarization conversion portion 22b are alternately arranged.

In this liquid crystal display device 1, the light emitted from the light source 14 is incident on the end face 16a of a light guide plate 16, and the total reflection between a first main surface 16b and a second main surface 16c in the light guide plate 16 is repeated for propagation. In a light deflection portion such as the concavo-convex shape optically designed such that light is emitted with substantially uniform brightness from the entire first main surface 16b, in a case where the propagation direction of the light propagating in the light guide plate 16 approaches a direction orthogonal to the main surface, the total reflection condition of the light that propagates in the light guide plate 16 is eliminated, the light is transmitted by the light transmission control layer 20 and is caused to be incident on the backlight incidence surface of the liquid crystal display element 40.

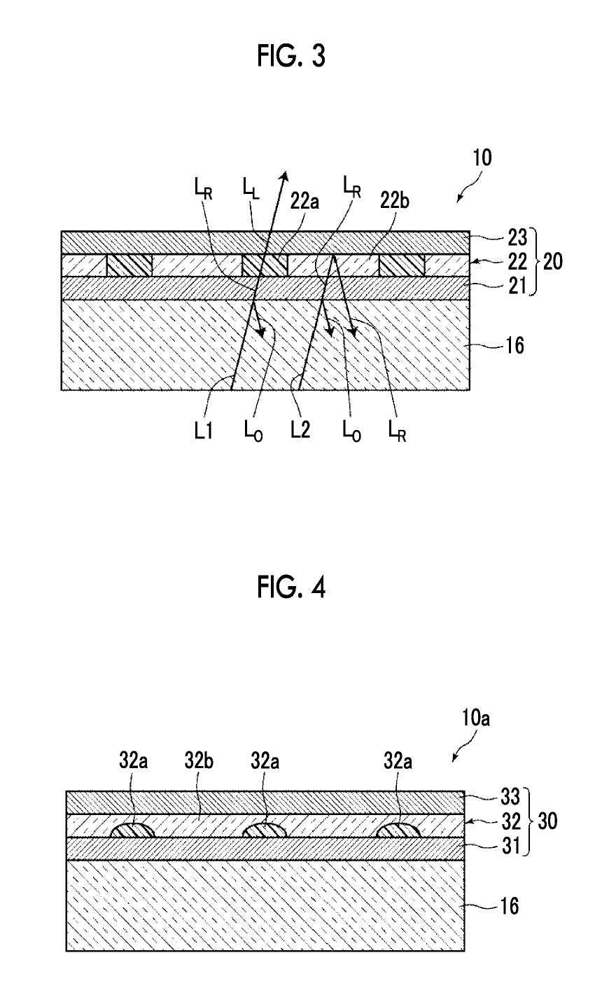

Here, the action of the light transmission control layer 20 of the light guide member 10 is described in detail with reference to FIG. 3. FIG. 3 is a schematic cross-sectional view illustrating a schematic configuration of the light guide member 10.

Here, a reflective polarizer layer 21 a reflective polarizer layer that transmits right-handed circularly polarized light and reflects the other polarized light, and a reflective polarizer layer 23 is a reflective polarizer layer that transmits left-handed circularly polarized light and reflects other polarized light, such that the polarization conversion portion 22a is a birefringent body having a retardation of λ/2.

First, among the light in which the propagation direction of the light propagates in the light guide plate 16 approaches the direction orthogonal to the main surface, the light L1 directed to the polarization conversion portion 22a is described. Among the light L1 having light in various polarization directions, the right-handed circularly polarized light L_{R} is transmitted by the reflective polarizer layer 21, the transmitted right-handed circularly polarized light L_{R} is converted to left-handed circularly polarized light L_{L} in the polarization conversion portion 22a having a retardation of λ/2, and this left-handed circularly polarized light L_{L} is transmitted by the reflective polarizer layer 21 and is incident on the backlight incidence surface of the liquid crystal display element 40. Among the light L1 having light in various polarization directions, light L_{O} other than the right-handed circularly polarized light L_{R} is reflected by the reflective polarizer layer 21 and returns to the light guide plate 16.

Next, among the light in which the propagation direction of the light propagating in the light guide plate 16 approaches the direction orthogonal to the main surface, the light L2 directed to the non-polarization conversion portion 22b is described. Among the light L2 having light in various polarization directions, the right-handed circularly polarized light L_{R} transmits the reflective polarizer layer 21, and the transmitted right-handed circularly polarized light L_{R} is incident on the reflective polarizer layer 23 without changing the polarization state. Therefore, the right-handed circularly polarized light L_{R} is reflected by the reflective polarizer layer 23 and is returned to the light guide plate 16 through the non-polarization conversion portion 22b and the reflective polarizer layer 21. Among the light L2 having light in various polarization directions, light L_{O} other than the right-handed circularly polarized light L_{R} is reflected by the reflective polarizer layer 21 and returns to the light guide plate 16.

That is, with regard to the light guide member 10, light can be emitted only from the region where the polarization conversion portion 22a is formed in the light transmission control layer 20, and thus even in a case where the liquid crystal display element 40 on which the light guide member 10 is laminated is folded, the light is leaked from an unintended portion (a region in which the polarization conversion portion 22a is not formed in the light transmission control layer 20), such that the decrease in the uniformity of the brightness of the backlight and/or the front brightness can be prevented.

Since the light emitted from the light guide member 10 already has polarizing properties, it is possible to omit a polarized light reflective-type brightness enhancement film and/or a polarizing plate that is generally provided between the liquid crystal display element 40 and the backlight unit and causes the light incident on the liquid crystal display element 40 to be predetermined polarized light. Therefore, it is possible to contribute to thinning, weight reduction, and cost reduction. Since light recursion is repeated only in the light guide member until desired polarization properties are obtained, the energy loss of light due to stray light or the like is small. Therefore, it is possible to contribute to high efficiency of the backlight.

On the contrary to the above, in a case where the reflective polarizer layer 21 is a reflective polarizer layer that transmits left-handed circularly polarized light and reflects the other polarized light and the reflective polarizer layer 23 is a reflective polarizer layer that transmits right-handed circularly polarized light and reflects the other polarized light or in a case where, with respect to the two reflective polarizer layers 21 and 23 having different reflection polarization directions, one reflective polarizer layer that transmits a predetermined linearly polarized light and reflects the other polarized light and the other reflective polarizer layer that transmits linearly polarized light of which angle is inclined by an angle of 90° with respect to one reflective polarizer layer and reflects the other polarized light are combined with each other, the principle of light transmission control is the same.

The configuration of the light transmission control layer 20 are not limited to an aspect in which both of the polarization conversion portion 22a and the non-polarization conversion portion 22b are completely buried in a portion between the reflective polarizer layers 21 and 23 in a lamination direction (vertical direction in FIG. 3) of the respective layers of the light transmission control layer 20 as illustrated in FIG. 3, but may be an aspect in which, a spherical segment-like polarization conversion portion 32a having a lower height than a gap between reflective polarizer layers 31 and 33 of a light transmission control layer 30 is formed in a polarization conversion layer 32, such that the circumference thereof is buried with a non-polarization conversion portion 32b, as illustrated in FIG. 4.

The light source 14 may be a point light source such as an LED (Light Emitting Diode) or may be a line light source such as a rod-like fluorescence, and various kinds of well-known light sources used in an edge light-type backlight unit in the related art can be used.

According to the present embodiment, the edge light-type backlight unit in which the light is incident from the end face 16a of the light guide plate 16 is used as the backlight unit, but the present invention is not limited to the edge light-type backlight unit and may be a direct-type backlight unit in which light is incident from the second main surface 16c of the light guide plate 16.

The back surface side reflection plate 12 reflects the light emitted from the second main surface 16c of the light guide plate 16 to the light guide plate 16. By including the back surface side reflection plate 12, light utilization efficiency can be enhanced. The back surface side reflection plate 12 is not particularly limited, and various well-known plates may be used. In order to efficiently use light, it is preferable to have a reflective face having low absorption and high reflectance. For example, it is preferable to have a reflective face made of a multilayer film using white PET or a polyester-based resin, but the present invention is not limited thereto. Examples of the multilayer film using a polyester-based resin include ESR (trade name) manufactured by The 3M Company.

As illustrated in FIG. 1, the back surface side reflection plate 12 may be arranged to be spaced from the second main surface 16c of the light guide plate 16 or may be adhered to the second main surface 16c of the light guide plate 16 via a pressure sensitive adhesive or the like. In a case where the back surface side reflection plate 12 is adhered to the light guide plate 16, the light propagating through the light guide plate 16 is repeatedly reflected between the first main surface 16b of the light guide plate 16 and a reflective face 12a of the back surface side reflection plate 12 to be guided. A wavelength conversion pattern layer or a wavelength conversion layer which is represented by quantum dots may be arranged between the back surface side reflection plate 12 and the reflective polarizer layer 23. It is possible to efficiently perform wavelength conversion by light repeatedly retrograded in the light guide plate.

A second embodiment of the liquid crystal display device of the present invention is described. According to the present embodiment, a case where an in-plane brightness homogenizing layer for homogenizing the in-plane brightness distribution is comprised in the light guide member of the backlight unit is described. According to the present embodiment, the same reference numerals are provided to the same configurations as the embodiment described above, and detailed descriptions thereof are omitted.

FIG. 6 is a schematic cross-sectional view illustrating a schematic configuration of the liquid crystal display device according to the present embodiment.

The liquid crystal display device 1a of the present embodiment has the liquid crystal display element 40 in which backlight is incident on the backlight incidence surface on the opposite side to the image display surface, a backlight unit having the light source 14 in which light is incident on the light guide member l0a and an end face of the light guide member 10a, and the reflection plate 12.

The light guide member 10a has the light guide layer 16 that guide incident light and causes the light to be emitted from at least one main surface and the light transmission control layer 20 that is integrally laminated on the light guide layer 16 on a main surface side from which light of the light guide layer 16 is emitted and controls a region in which light is transmitted, and further comprises an in-plane brightness homogenizing layer 50 for homogenizing an in-plane brightness distribution on an emitting surface on which the light of the light transmission control layer 20 is emitted.

The in-plane brightness homogenizing layer 50 is formed of a reflecting portion 50a arranged immediately above the polarization conversion portion 22a and a light guide portion 50b and is integrally laminated on the light transmission control layer 20 on an emitting surface side of the light transmission control layer 20.

As the in-plane brightness homogenizing layer 50, various kinds of well-known plate-like materials (sheet-like materials) can be used. The in-plane brightness homogenizing layer 50 may be formed of a resin having high transparency as in a light guide plate used for a well-known backlight device, and examples thereof include an acrylic resin such as polyethylene terephthalate, polypropylene, polycarbonate, and polymethyl methacrylate, benzyl methacrylate, MS resin (polymethacryl styrene), a cycloolefin polymer, a cycloolefin copolymer, and cellulose acylate such as cellulose diacetate and cellulose triacetate. The resin is not limited to a thermoplastic resin, and for example, an ionizing radiation curable resin such as an ultraviolet curable resin or an electron beam curable resin, or a thermosetting resin can also be used. The refractive index of the in-plane brightness homogenizing layer 50 needs to greater than that of the air.

The reflecting portion 50a has a concave shape concave from the emitting surface side of the in-plane brightness homogenizing layer 50 to the opposite incident surface side. In view of homogenizing reflected light, the reflecting portion 50a may have a shape having a surface that is inclined with respect to the emitting surface of the in-plane brightness homogenizing layer 50 so as to isotropically reflect light, such as a conical shape, a polygonal pyramidal shape, or a hemisphere. The reflecting portion 50a refers to a surface facing the incident surface side of the concave shape. In order to isotropically distribute in the in-plane of the light, the shape of the upper surface of the polarization conversion portion 22a is preferably a circular shape.

The reflecting portion 50a is provided immediately above the polarization conversion portion 22a so as to guide the light emitted from the polarization conversion portion 22a in the in-plane direction of the in-plane brightness homogenizing layer 50. Specifically, the center of the bottom surface of the reflecting portion 50a is arranged on a line perpendicular to the emitting surface of the light transmission control layer 20 from the center of the circular polarization conversion portion 22a such that positions of the center of the bottom surface of the reflecting portion 50a and the center of the polarization conversion portion 22a coincide with each other. In a case where the reflecting portion 50a has a polygonal pyramid shape, the center of a circumscribed circle or an inscribed circle in contact with the polygonal shape of the bottom surface or the center of the polygonal shape may be aligned as the center of the bottom surface. In order that the light emitted from the polarization conversion portion 22a does not transmit the in-plane brightness homogenizing layer 50 to be directly emitted, it is preferable that the shape and size of the bottom surface is determined such that a shape in which the upper surface shape of the polarization conversion portion 22a is perpendicularly projected to the emitting surface of the in-plane brightness homogenizing layer 50 is inside of the bottom surface of the reflecting portion 50a.

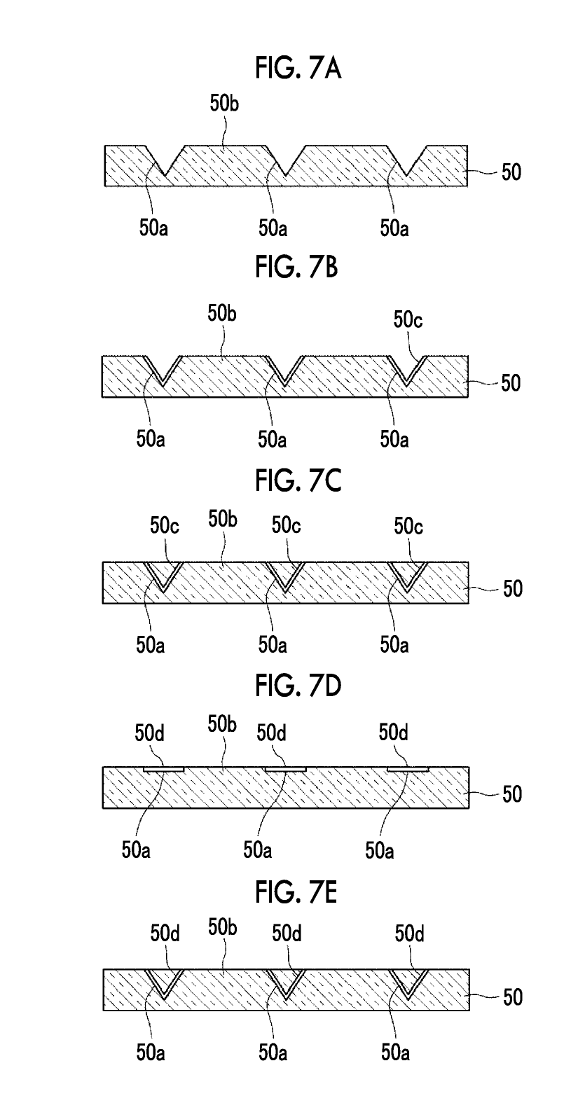

As illustrated in FIG. 7A, the reflecting portion 50a may be left in a concave shape without flattening the emitting surface side of the in-plane brightness homogenizing layer 50. As illustrated in FIG. 7B, as the reflecting portion 50a, a semi-transmissive reflection film 50c (a metal thin film, a layer including a cholesteric liquid crystal, or a layer including fine particles) formed of a material having reflecting characteristics may be formed along the sides of the concave shape. Since the amount of light to be transmitted and the amount of light to be reflected can be adjusted by forming the semi-transmissive reflection film 50c, the in-plane brightness distribution can be easily controlled. As illustrated in FIG. 7C, the concave shape is filled with a material as in the light guide portion 50b such that the concave shape is embedded.

The reflecting portion 50a may have a structure that can reflect light transmitted from the polarization conversion portion 22a and guide the light to the light guide portion 50b and may be formed of a material that diffuses and reflects the reflecting portion 50a. Specifically, the reflecting portion 50a may be formed of a diffuse reflection film 50d (such as a film of a white material such as barium sulfate or titanium oxide, a PET film including a fine foam structure).

As illustrated in FIG. 7D, the planar diffuse reflection film 50d is provided on an emitting surface side of the in-plane brightness homogenizing layer 50 immediately above the polarization conversion portion 22a. Also in a case where the diffuse reflection film 50d is provided, the shape of the upper surface of the polarization conversion portion 22a is preferably a circular shape for isotropical distribution in the in-plane of the light. The shape and size of the diffuse reflection film 50d are formed to have substantially the same shape and size of the polarization conversion portion 22a, and positions of the center of the polarization conversion portion 22a and the center of the diffuse reflection film 50d are caused to coincide with each other. The diffuse reflection film 50d may not have a circular shape, but preferably have a size in which the reflecting portion 50a covers the polarization conversion portion 22a.

As illustrated in FIG. 7E, the diffuse reflection film 50d may have a concave shape recessed from the emitting surface side of the in-plane brightness homogenizing layer 50 to the opposite incident surface side. As described above, the concave shape may be a shape having a surface inclined with respect to the emitting surface of the in-plane brightness homogenizing layer 50 such as a conical shape, a polygonal pyramidal shape, or a hemisphere shape. Though not illustrated, the diffuse reflection film 50d may have a concave shape as in FIG. 7B without change. As described above, it is preferable that the arrangement is performed such that positions of the center of the bottom surface of the reflecting portion 50a and the center of the polarization conversion portion 22a coincide with each other. The shape and the size of the bottom surface are determined such that a shape in which an upper surface shape of the polarization conversion portion 22a is perpendicularly projected to the emitting surface of the in-plane brightness homogenizing layer 50 is inside of the bottom surface of the reflecting portion 50a.

Specific examples of the configuration of the reflecting portion 50a are provided in Examples described below.

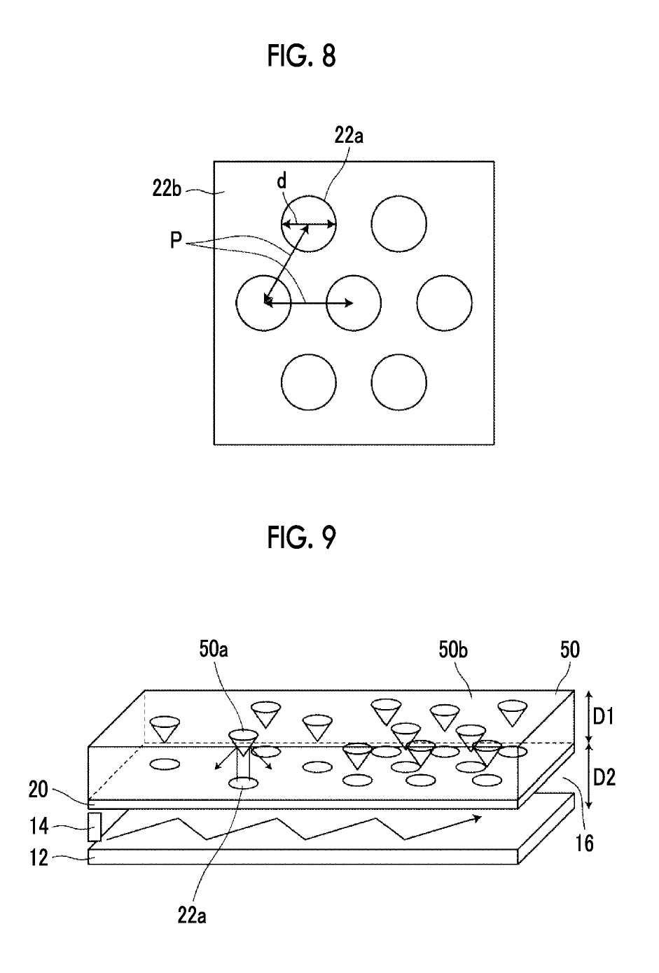

The width of the reflecting portion 50a is determined corresponding to the width of the polarization conversion portion 22a, and a pitch between the reflecting portions 50a is determined so as to coincide with a pitch(>the width of the polarization conversion portion 22a) of the polarization conversion portion 22a. In a case where the polarization conversion portion 22a is arranged in a pattern of FIG. 8, the reflecting portion 50a is also arranged in the same pattern. A width d of the reflecting portion 50a refers to a diameter of a circle of the bottom surface in a case where the reflecting portion 50a has a conical shape and one side of the polygonal shape on the bottom surface, the longest distance among the crossing lines of the polygonal shape, or an equivalent circle diameter of the polygonal shape in a case where the reflecting portion 50a has a polygonal pyramid shape. A pitch p refers to a distance between the centers of the circles on the bottom surface in a case where the reflecting portion 50a has a conical shape. In a case where the reflecting portion 50a has a polygonal pyramid shape, the pitch p refers to the distance between the centers of the polygonal shape on the bottom surface. In the same manner, the width d of the polarization conversion portion 22a refers to a diameter of the circle of the polarization conversion portion 22a, and the pitch p of the polarization conversion portion 22a refers to a distance between the centers of the circles.

In a case where the reflecting portion 50a is provided immediately above the polarization conversion portion 22a in this manner, it is preferable that the width d and the pitch p of the polarization conversion portion 22a are respectively 0.1 mm or more and less than 1 mm. In view of the pitch manufacturing efficiency, the width and the pitch of the polarization conversion portion 22a are preferably 0.1 mm or more. In a case where the width d and the pitch p of the polarization conversion portion 22a are the width of 1 mm or less, the light reflected on the reflecting portion 50a can be diffused in the in-plane direction of the light guide portion 50b in a degree of sufficiently homogenizing the in-plane brightness distribution.

The width of the reflecting portion 50a is preferably 1.0 time or more and less than 1.2 times and particularly preferably 1.0 or more and less than 1.1 times with respect to the width of the polarization conversion portion 22a. In a case where the width is caused to be 1.0 time or more, the width of the polarization conversion portion 22a becomes greater than the width of the reflecting portion 50a, and thus the light that is transmitted from the polarization conversion portion 22a by the in-plane brightness homogenizing layer 50 and is directly transmitted in the viewing direction disappears, and thus the brightness distribution can be homogenized. Compared with a case where the width is caused to be 1.2 times or more, in a case where the width is caused to be 1.0 time or more and less than 1.2 times, it is possible to increase the light that is transmitted in the viewing direction from the non-polarization conversion portion 22b such that the brightness distribution can be sufficiently homogenized.

In FIG. 8, the case where the polarization conversion portions 22a are arranged in a staggered arrangement has been described, but the reflecting portions 50a may be provided immediately above the polarization conversion portions 22a, respectively, in a lattice form arrangement or random arrangement. In a case where the light source is incident from the end face of the light guide member 10a, the polarization conversion portion 22a is formed such that the arrangement density thereof may become greater as it goes away from the light source position or the area of one polarization conversion portion 22a may be increased. FIG. 9 illustrates an example of the arrangement of the polarization conversion portion 22a and the reflecting portion 50a of the light guide member 10a in a case where the polarization conversion portion 22a is formed such that the arrangement density thereof is increased as it goes away from the light source position.

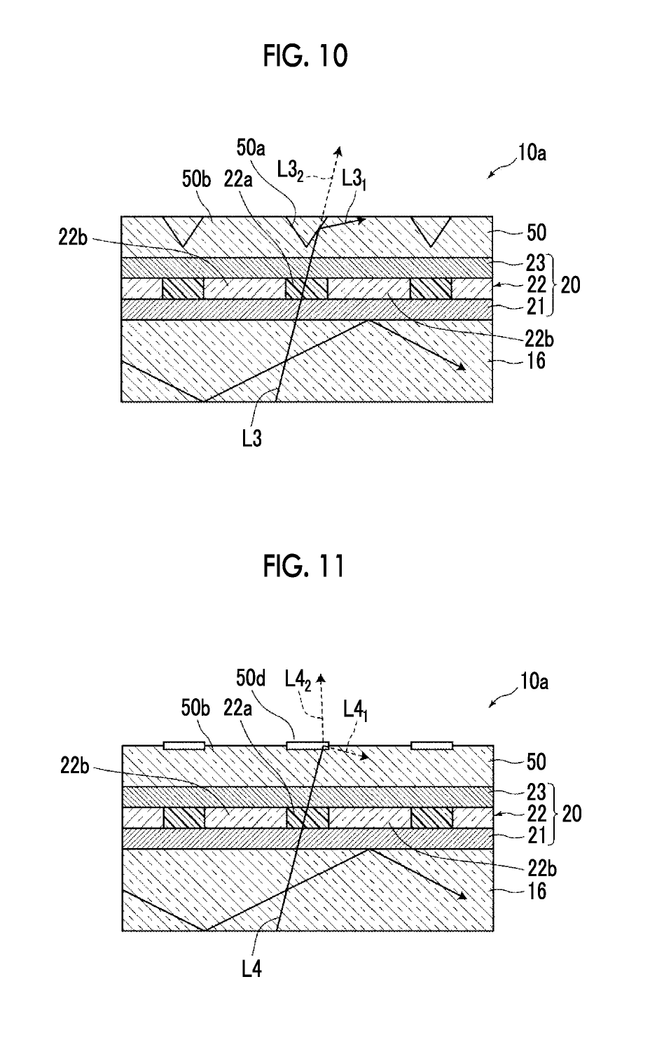

Here, the action of the in-plane brightness homogenizing layer 50 is described in detail with reference to FIGS. 10 and 11. FIGS. 10 and 11 are schematic cross-sectional views illustrating a schematic configuration of the light guide member 10a.

As illustrated in FIG. 10, in a case where the reflecting portion 50a has a concave shape (including a case where the semi-transmissive reflection film 50c is formed and a case where the diffuse reflection film 50d is formed), with respect to light L3 that is transmitted by the polarization conversion portion 22a, a propagation direction of a portion of the light can be bent to a direction of L3₁ by the reflecting portion 50a, and thus the light is transmitted by the light guide portion 50b to be emitted. A portion of the light is transmitted by the reflecting portion 50a and is emitted in a direction of L3₂. The light L3₁ guided to the light guide portion 50b is emitted from a position separated from the polarization conversion portion 22a. Otherwise, according to the direction of the light L3₁ that is guided to the light guide portion 50b is further reflected on the surface of the reflective polarizer layer 23 and is emitted. Accordingly, the in-plane distribution of the light emitted from the light guide member l0a can be homogenized.

Otherwise, as illustrated in FIG. 11, in a case where the reflecting portion 50a is the diffuse reflection film 50d having a planar shape illustrated in FIG. 7D, light L4 transmitted through the polarization conversion portion 22a is diffused in the diffuse reflection film 50d, a portion of light L4₁ is emitted after returning in the in-plane direction of the in-plane brightness homogenizing layer 50, and a portion of light L4₂ is transmitted by the diffuse reflection film 50d to be emitted.

In the above, as illustrated in FIG. 3, with respect to the configuration of the light transmission control layer 20, together with the polarization conversion portion 22a and the non-polarization conversion portion 22b, the in-plane brightness homogenizing layer 50 is provided in the aspect in which the respective layers of the light transmission control layers 20 in the lamination direction are completely buried between the reflective polarizer layers 21 and 23, but as illustrated in FIG. 4, the spherical segment-like polarization conversion portion 32a having the height lower than the gap between the reflective polarizer layers 31 and 33 may have an aspect in which the in-plane brightness homogenizing layer 50 is provided on the light transmission control layer 30 comprising the polarization conversion layer 32.

It is preferable that thicknesses D2 of the light transmission control layer 20 and the light guide layer 16 are 0.1 mm to 1.0 mm, the thickness D1 of the in-plane brightness homogenizing layer 50 is 0.1 mm to 1.0 mm, and the sum of D1 and D2 is 2.0 mm or less (see FIG. 8). By causing the film thicknesses in these ranges, the present invention can be applied to a thin liquid crystal display device such as a smart phone or a tablet.

In this manner, in the light guide member 10a, the light is emitted only from a region in which the polarization conversion portion 22a is formed in the light transmission control layer 20, and the in-plane brightness homogenizing layer 50 is provided on the light transmission control layer 20. Therefore, the light emitted from the polarization conversion portion 22a is guided in the reflecting portion 50a in the in-plane direction such that the light is diffused to not only a portion immediately above the polarization conversion portion 22a but also an edge part of the polarization conversion portion 22a, and thus the uniformity of the brightness of the backlight can be enhanced.

The liquid crystal display element 40 and the backlight unit are generally spaced from each other such that the light of the backlight is diffused and incident on the liquid crystal display element 40 in the even brightness, but since the uniformity of the brightness of the backlight is increased, the gap between the liquid crystal display element 40 and the backlight unit can be caused to be narrowed down, thereby contributing to further thinning.

In the above, the liquid crystal display device according to the embodiment of the present invention is described in detail, but the present invention is not limited to the above examples, and it is obvious that various modifications and changes can be performed without departing from the gist of the present invention.

### EXAMPLES

Hereinafter, the present invention is specifically described with reference to the examples. A material, an amount used, a ratio, a treatment detail, a treatment order, and the like provided below can be suitably changed without departing from the gist of the present invention. Other configuration can be adopted other than the following configurations without departing from the gist of the present invention. That is, the configuration of the present invention should not be limited by the following specific examples. Unless described otherwise, “parts” and “%” are based on mass.

### Comparative Example 1

As a flat light guide member which was not folded, a light guide member consisting of only an acrylic light guide plate having a thickness of 40 μm and an A4 size was manufactured.

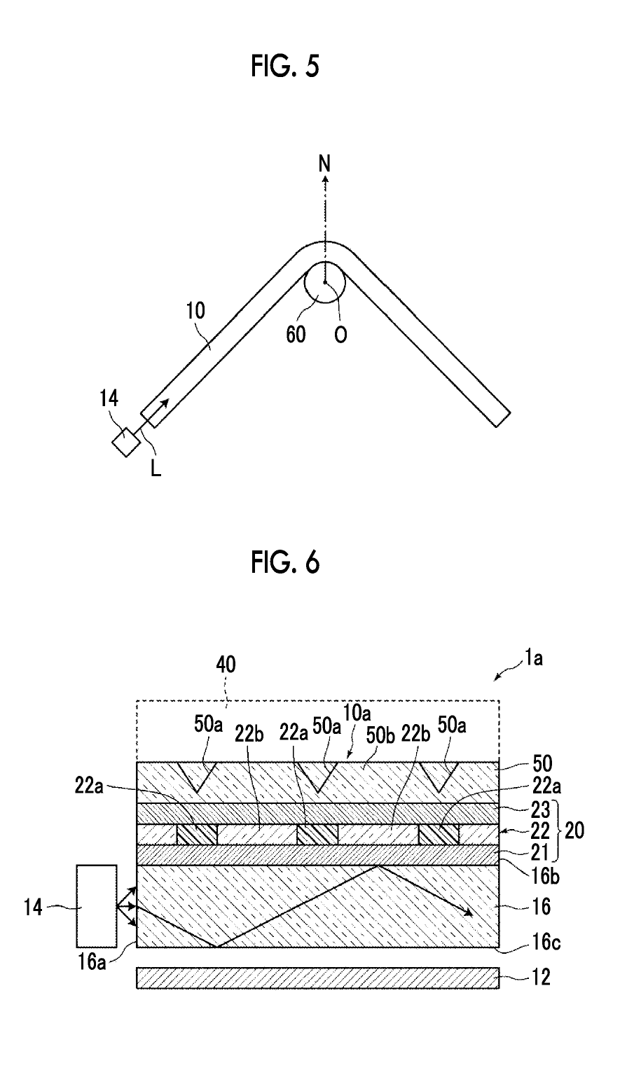

As shown in FIG. 5, as a folded light guide member to be compared, an iron bar 60 having a radius of 20 mm and heated to about 160° was pressed near the center of an acrylic light guide plate having the same A4 size and slowly bent, so as to manufacture a light guide member folded by 90°.

### Example 1

First, a light guide member 1-1 was manufactured.

A light transmission control layer having the following configuration was laminated on a flat acrylic light guide member of Comparative Example 1.

<<Manufacturing of First Reflective Polarizer Layer>>

The following composition was stirred and dissolved in a container kept at 25° C. so as to prepare a cholesteric liquid crystal ink liquid (liquid crystal composition). A right twist chiral agent A having the following structure and a left twist chiral agent B having the following structure were included in a cholesteric liquid crystal ink liquid(liquid crystal composition), and additionally, a liquid described in the following “cholesteric liquid crystal ink liquid (part by mass)” was contained. In the cholesteric liquid crystal ink liquid (liquid crystal composition), without changing an amount (part by mass) of a material contained other than the followings, only types of the chiral agent which was the right twist chiral agent A or the left twist chiral agent B and amounts (part by mass) of the right twist chiral agent A and the left twist chiral agent B were adjusted as presented in Table 1 below according to center selection wavelengths so as to prepare a cholesteric liquid crystal for reflecting a specific center selection wavelength. In a case where dots that reflect right-handed circularly polarized light were formed, as the chiral agent, only the right twist chiral agent A was added by an amount (part by mass) corresponding to the center selection wavelength illustrated in Table 1 below. In a case where dots that reflect the left-handed circularly polarized light were formed, as the chiral agent, only the left twist chiral agent B was added by an amount (part by mass) corresponding to the center selection wavelength presented in Table 1.

<Right Twist Cholesteric Liquid Crystal Ink Liquid (Part by Mass)>

| | |
|---|---|
| Methoxyethyl acrylate | 145.0 |
| Mixture of the following rod-like liquid | 100.0 |
| crystal compounds | |
| IRGACURE (registered trademark) 819 | 10.0 |
| (manufactured by BASF SE) | |
| Right twist chiral agent A having the | See Table 1 below |
| following structure | |
| Surfactant having the following structure | 0.08 |

<Left Twist Cholesteric Liquid Crystal Ink Liquid (Part by Mass)>

| | |
|---|---|
| Methoxyethyl acrylate | 145.0 |
| Mixture of the following rod-like liquid | 100.0 |
| crystal compounds | |
| IRGACURE (registered trademark) 819 | 10.0 |
| (manufactured by BASF SE) | |
| Left twist chiral agent B having the | See Table 1 below |
| following structure | |
| Surfactant having the following structure | 0.08 |

Rod-like liquid crystal compound

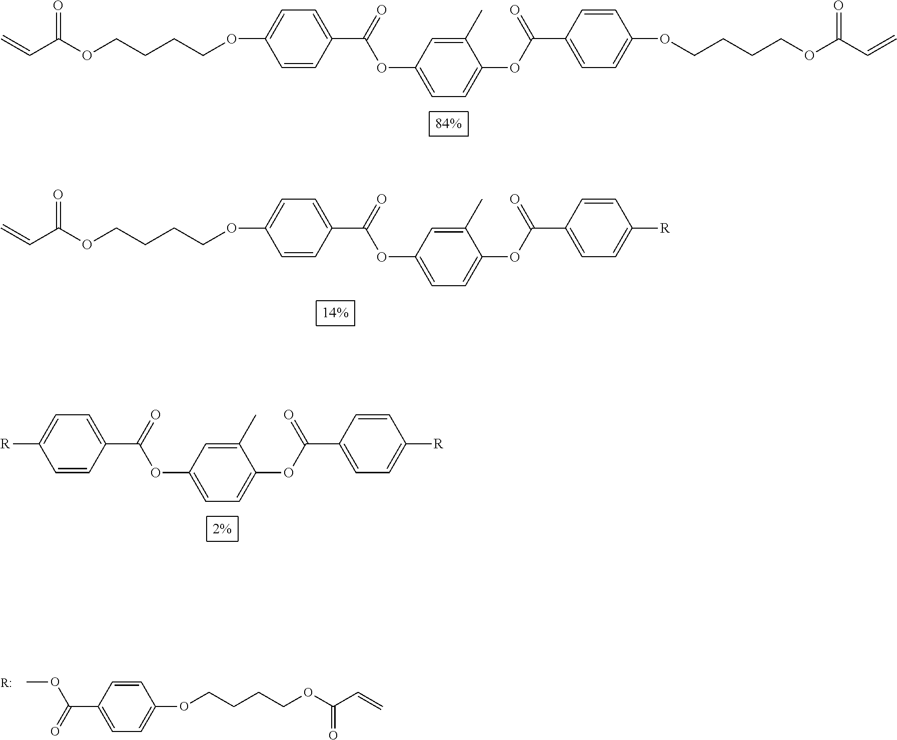

The numerical number is mass %. R is a group bonded by an enzyme.
Right twist chiral agent A

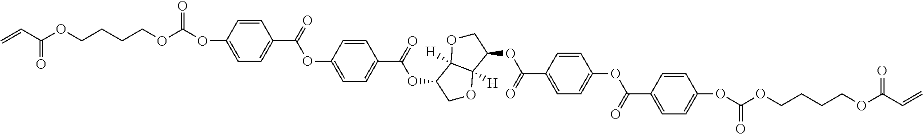 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

Left twist chiral agent B

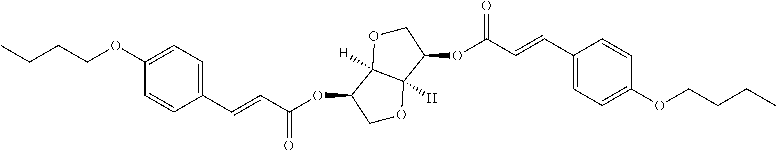 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

### Surfactant

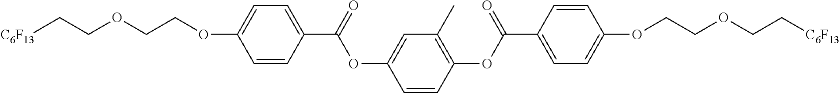

Based on Table 1 below, a cholesteric liquid crystal ink liquid was prepared according to the center selection wavelength and the form of reflected polarized light.

TABLE 1

| | Part by mass | Part by mass |
|---|---|---|
| Center selection | of right twist | of left twist |
| wavelength (nm) | chiral agent A | chiral agent B |
| 450 | 7.61 | 9.59 |
| 550 | 5.78 | 7.85 |
| 650 | 4.66 | 6.64 |
| 750 | 4.52 | 5.76 |

One surface of the flat acrylic light guide member of Comparative Example 1 was coated with an alignment film coating liquid consisting of 10 parts by mass of polyvinyl alcohol and 371 parts by mass of water, and the alignment film coating liquid was dried, so as to form an alignment film having a thickness of 1 μm. Next, a rubbing treatment was performed on the alignment film continuously in a direction parallel to the longitudinal direction of the film.

A right twist liquid crystal ink with a center selection wavelength of 450 nm in Table 1 was applied to the alignment film using a bar coater, was dried at room temperature for 10 seconds, then was heated (alignment ripened) in an oven at 100° C. for two minutes, and was irradiated with ultraviolet rays for 30 seconds, so as to manufacture a cholesteric liquid crystal layer having a thickness of 5 μm.

The cholesteric liquid crystal layer was coated with a right twist liquid crystal ink in a center selection wavelength of 550 nm in Table 1 by using a bar coater, the ink was dried at room temperature for 10 seconds, then was heated (alignment ripened) in an oven at 100° C. for two minutes, and was irradiated with ultraviolet rays for 30 seconds, so as to manufacture a layer by laminating a cholesteric liquid crystal having a thickness of 5 μm on the underlayer.

The layer was coated with a right twist liquid crystal ink having a center selection wavelength of 650 nm presented in Table 1 by using a bar coater, the ink was dried at room temperature for 10 seconds, then was heated (alignment ripened) in an oven at 100° C. for two minutes, and was irradiated with ultraviolet rays for 30 seconds, so as to manufacture a layer by laminating a cholesteric liquid crystal having a thickness of 5 μm on the underlayer.

The layer was coated with a right twist liquid crystal ink having a center selection wavelength of 750 nm presented in Table 1 by using a bar coater, the ink was dried at room temperature for 10 seconds, then was heated (alignment ripened) in an oven at 100° C. for two minutes, and was irradiated with ultraviolet rays for 30 seconds, so as to manufacture a layer by laminating a cholesteric liquid crystal having a thickness of 5 μm on the underlayer.

In this manner, a first reflective polarizer layer, which was a laminated layer of four cholesteric liquid crystals, was manufactured. The cross section was observed with a scanning electron microscope to find that the first reflective polarizer layer had a structure in which four layers having helical axes in a layer normal direction and having different cholesteric pitches were laminated and a pitch thereof corresponded to the center selection wavelengths of 450, 550,650, and 750 nm. The reflection spectrum was measured with Axoscan to confirm that the right-handed circularly polarized light was reflected by four reflection bands mainly of 450, 550, 650, and 750 nm and to confirm that the first reflective polarizer layer had reflection bands of the right-handed circularly polarized light which became wider as it goes from the visible light range toward the near-infrared range.

<<Manufacturing of Polarization Conversion Layer>>

As below, a birefringent pattern transfer foil F-1 which was a polarization converting member for patterning a λ/2 layer was manufactured.

<Preparation of Release Layer Coating Liquid FL-1>

The following composition was prepared and filtered with a polypropylene filter having a pore size of 0.45 μm to be used as a release layer coating liquid FL-1.

Release Layer Coating Liquid Composition (Part by Mass)

| | |
|---|---|
| Polymethyl methacrylate (mass average molecular | 16.00 |
| weight (weight-average molecular weight) 50,000) | |
| Methyl ethyl ketone | 74.00 |
| Cyclohexanone | 10.00 |

<Preparation of Alignment Layer Coating Liquid AL-1>

The following composition was prepared and was filtered with a polypropylene filter having a pore size of 30 μm, to be used as an alignment layer coating liquid AL-1.

Alignment Layer Coating Liquid Composition (Part by Mass)

| | |
|---|---|
| Polyvinyl alcohol (PVA205, manufactured | 3.23 |
| by Kuraray Co., Ltd.) | |
| Polyvinyl pyrrolidone (Luvitec K30, | 1.50 |
| manufactured by BASF SE) | |
| Distilled water | 57.11 |
| Methanol | 38.16 |

<Preparation of Optically Anisotropic Layer Coating Liquid LC-1>

The following composition was prepared and was filtered with a polypropylene filter having a pore size of 0.45 μm, to be used as an optically anisotropic layer coating liquid LC-1.

LC-1-1 was a liquid crystal compound having two reactive groups: one of the two reactive groups is was an acryloyl group which was a radical reactive group, and the other was an oxetane group which was a cationic reactive group.

Optically anisotropic layer coating liquid composition (part by mass)

| | |
|---|---|
| Polymerizable liquid crystal compound (LC-1-1) | 32.88 |
| Horizontal alignment agent (LC-1-2) | 0.05 |
| Cationic photopolymerization initiator (CPI100-P, manufactured by San-Apro Ltd.) | 0.66 |
| Polymerization control agent (IRGANOX1076, manufactured by Ciba Specialty Chemicals plc.) | 0.07 |
| Methyl ethyl ketone | 46.34 |
| Cyclohexanone | 20.00 |

(LC-1-1) 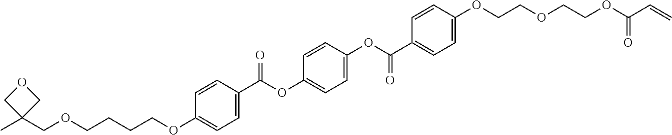 [SMILES: C=CC(=O)OCCOCCOc1ccc(C(=O)Oc2ccc(OC(=O)c3ccc(OCCCCOCC4(C)COC4)cc3)cc2)cc1]
(LC-1-2)

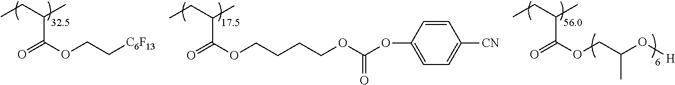

In Formula 6, the numerical value is mass %.

<Preparation of Additive Layer Coating Liquid OC-1>

The following composition was prepared and was filtered with a polypropylene filter having a pore size of 0.45 μm to be used as a transfer adhesive layer coating liquid OC-1. As the radical photopolymerization initiator RPI-1, 2-trichloromethyl-5-(p-styrylstyryl) 1,3,4-oxadiazole was used. B-1 is a copolymer of methyl methacrylate and methacrylic acid, and the copolymerization compositional ratio (molar ratio)=60/40.

Additive Layer Coating Liquid Composition (Part by Mass)

| | |
|---|---|
| Binder (B-1) | 7.63 |
| Radical photopolymerization initiator (RPI-1) | 0.49 |
| Surfactant solution | 0.03 |
| (MEGAFACE F-176 PF, manufactured by DIC Corporation) | |
| Methyl ethyl ketone | 68.89 |
| Ethyl acetate | 15.34 |
| Butyl acetate | 7.63 |

(B-1)

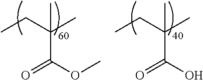

<Preparation of Heat-Sensitive Adhesive Layer Coating Liquid AD-2>

The following composition was prepared and filtered with a polypropylene filter having a pore size of 0.45 μm to be used as an adhesive layer coating liquid AD-2.

Heat-Sensitive Adhesive Layer Coating Liquid Composition (Part by Mass)

| | |
|---|---|
| Polyester-based hot melt resin solution | 37.50 |
| (PES375S40, manufactured by Toagosei Co., Ltd.) | |
| Methyl ethyl ketone | 62.50 |

<Manufacturing of Birefringent Pattern Manufacturing Material P-1>

Aluminum was deposited by a thickness of 60 nm on a polyethylene naphthalate film (TEONEX Q 83, manufactured by Teijin Film Solutions Limited) having a thickness of 50 μm so as to manufacture a support with a reflective layer. A surface vapor-deposited with aluminum by using a wire bar was coated with the release layer coating liquid FL-1, and the liquid was dried to form a release layer. The dry film thickness of the release layer was 2.0 μm. The dried release layer was coated with the alignment layer coating liquid AL-1 by using a wire bar, and the liquid was dried to obtain an alignment layer. The dry film thickness of the alignment layer was 0.5 μm.

Subsequently, the alignment layer was rubbing-treated and coated with the optically anisotropic layer coating liquid LC-1 by using a wire bar, the liquid was dried at a film surface temperature of 90° C. for two minutes to obtain a liquid crystal phase state and irradiated with ultraviolet rays by using an air-cooled metal halide lamp (manufactured by Eye Graphics Co., Ltd.) of 160 W/cm in air to fix the alignment state, such that an optically anisotropic layer having a thickness of 3 μm was formed. In this case, the illuminance of the ultraviolet rays was 600 mW/cm² in the UV-A region (integrating accumulation at the wavelength of 320 nm to 400 nm), and the irradiation amount was 300 mJ/cm² in the UV-A region. Finally, the optically anisotropic layer was coated with the additive layer coating liquid 0C-1 by using a wire bar, and the liquid was dried to form an additive layer having a film thickness of 0.8 μm, such that a birefringent pattern manufacturing material P-1 was manufactured.

<Manufacturing of Birefringent Pattern Transfer Foil F-1>

The birefringent pattern manufacturing material P-1 was subjected to pattern exposure by using a digital exposure machine (INPREX IP-3600H, manufactured by Fujifilm Corporation) by laser scanning exposure using an exposure amount of 0 mJ/cm², 40 mJ/cm². The area ratio of 40 mJ/cm² was 10% of the total area. Thereafter, heating was performed for 15 minutes by using a far-infrared heater continuous furnace, such that the film surface temperature became 210° C., so as to pattern the optically anisotropic layer.

Finally, the additive layer was coated with the heat-sensitive adhesive layer coating liquid AD-2 by using a wire bar, and the liquid was dried to form a heat-sensitive adhesive layer having a film thickness of 2.0 μm, and the birefringent pattern transfer foil F-1 was manufactured, so as to obtain a polarization conversion layer. In a case where the birefringent pattern transfer foil F-1 was transferred to a glass substrate so as to measure retardation, so as to find that the retardation was approximately 0 nm in the irradiation region of 0 mJ/cm² and 270 nm in the irradiation region of 40 mJ/cm².

The polarization conversion layer (the birefringent pattern transfer foil F-1) was transferred by hot pressing onto the aforementioned first reflective polarizer layer by using a laminator at a roller temperature of 150° C., a contact pressure of 0.2 MPa, and a transportation speed of 1.0 m/min.

<<Manufacturing of Second Reflective Polarizer Layer>>

PET (thickness of 75 μm) manufactured by Fujifilm Corporation was prepared as a temporary support, and rubbing treatment was continuously performed. A second reflective polarizer layer was manufactured on the temporary support as below.

The method of manufacturing the second reflective polarizer layer is the same as the method of manufacturing the first reflective polarizer layer except that a support of the first reflective polarizer layer was changed to a temporary support, and a cholesteric liquid crystal ink liquid in which the right twist chiral agent A was changed to the left twist chiral agent B was used (see Table 1). In this manner, the second reflective polarizer layer was manufactured.

In the same manner as in the first reflective polarizer layer, the cross section was observed with a scanning electron microscope to find that the second reflective polarizer layer had a structure in which four layers having helical axes in a layer normal direction and having different cholesteric pitches were laminated and a pitch thereof corresponded to 450, 550,650, and 750 nm. The reflection spectrum was measured with Axoscan to confirm that the left-handed circularly polarized light was reflected by four reflection bands mainly of the center selection wavelengths of 450, 550, 650, and 750 nm and to confirm that the second reflective polarizer layer had reflection bands of the left-handed circularly polarized light which became wider as it goes from the visible light range toward the near-infrared range.

The coated surface of the second reflective polarizer layer and the surface where the λ/2 layer was present were bonded by using SK2057 manufactured by Soken Chemical & Engineering Co., Ltd., and after bonding, the temporary support on the second reflective polarizer layer side was peeled off, so as to obtain a flat the light guide member 1-1 in which the light transmission control layer 20 obtained by laminating a first reflective polarizer layer, a polarization conversion layer, and a second reflective polarizer layer on the acrylic light guide plate in this order was formed as in the cross section shape illustrated in FIG. 1.

Subsequently, a light guide member 1-2 was manufactured. First, in the manufacturing of the first reflective polarizer layer, except that PET (thickness of 75 μm) manufactured by Fujifilm Corporation which was a temporary support was used instead of using the flat acrylic light guide member and the first reflective polarizer layer was transferred to the polarization conversion layer, in the same manner as in the light guide member 1-1, a transfer member obtained by laminating the second reflective polarizer layer, the polarization conversion layer, and the first reflective polarizer layer on the temporary support in this order was manufactured.

Subsequently, layers were transferred from the temporary support to the acrylic light guide member folded at 90°, such that the first reflective polarizer layer, the polarization conversion layer, and the second reflective polarizer layer were in this order. At this point, the folded acrylic light guide member and the first reflective polarizer layer were bonded by using SK2057 manufactured by Soken Chemical & Engineering Co., Ltd.

The light guide member 1-2 having a 90° folded portion was manufactured.

### Example 2

In the light guide members 1-1 and 1-2 of Example 1, the first and second reflective polarizer layers of the light transmission control layer were changed as below.

Specifically, a linearly polarized light reflective film was bonded to one surface of the acrylic light guide plate having a flat or folded portion which was used in Comparative Example 1 as the first reflective polarizer layer with SK2057 manufactured by Soken Chemical & Engineering Co., Ltd., a polarization conversion layer was bonded thereto in the same manner as in Example 1, and the linearly polarized light reflective film as the second reflective polarizer layer was bonded thereto such that the polarization direction thereof was orthogonal to that of the first reflective polarizer layer with SK2057 manufactured by Soken Chemical & Engineering Co., Ltd., so as to manufacture a flat light guide member 2-1 and a light guide member 2-2 with a folded portion. As the linearly polarized light reflective film, iPad Air (registered trademark) manufactured by Apple Inc. was disassembled, and a film used as a brightness enhancement film was taken out to be used.

### Example 3

In the light guide member of Example 1, the polarization conversion layer of the light transmission control layer was changed to a liquid crystal dot λ/2 pattern layer.

The ink prescription prepared in the first reflective polarizer layer of Example 1 was changed only by excluding a chiral agent, so as to adjust a λ/2 pattern liquid crystal ink as illustrated in FIG. 4. This was ejected to the first reflective polarizer layer by an inkjet printer (DMP-2831, manufactured by Fujifilm Dimatix Inc.) on the entire surface of the first reflective polarizer layer at a dot center distance (pitch) of 80 μm in the same manner as described above, was dried at 95° C. for 30 seconds, and irradiated with ultraviolet rays at 500 mJ/cm² by an ultraviolet irradiation device at room temperature for hardening, so as to form spherical dots.

The coating amount was adjusted so that the average height per dot was 2.5 μm. In this manner, the layer functions as a patterning layer with a retardation of approximately λ/2. An overcoat layer (without retardation) was applied thereto, so as to bury the dots.

<Forming of Overcoat Layer>

The composition as below was stirred and dissolved in a container kept at 25° C. so as to prepare a coating liquid for overcoating.

Overcoating Coating Liquid 1 (Part by Mass)

| | |
|---|---|
| Acetone | 100.0 |
| KAYARAD DPCA-30 (manufactured by | 30.0 |
| Nippon Kayaku Co., Ltd.) | |
| EA-200 (manufactured by Osaka Gas | 70.0 |
| Chemical Co., Ltd.) | |
| IRGACURE (registered trademark) 819 | 3.0 |
| (manufactured by BASF SE) | |

The coating liquid 1 for overcoating prepared as above was applied from a portion above the liquid crystal dots by using a bar coater such that the liquid crystal dots were completely covered. Thereafter, heating was performed such that a film surface temperature became 50° C., drying was performed for 60 seconds, and the irradiation was performed with ultraviolet rays of 500 mJ/cm² by the ultraviolet irradiation device, the crosslinking reaction was allowed to proceed to form an overcoat layer. The film thickness from the polyethylene naphthalate substrate to the coating surface was 5 μm. Both of the average refractive index of the dots and the refractive index of the overcoat layer were 1.58.

The second reflective polarizer layer was transferred thereto in the same manner as in Example 1. In this manner, a flat light guide member 3-1 in which the polarization conversion layer of the light transmission control layer was used as the liquid crystal dot λ/2 pattern layer and a light guide member 3-2 with a folded portion were respectively manufactured as in the cross section shape illustrated in FIG. 4.

### Example 4

In the light guide member of Example 3, the first and second reflective polarizer layers of the light transmission control layer were changed in the same manner as in Example 2.

### Example 5

In the light guide member of Example 3, the polarization conversion layer of the light transmission control layer was changed to a pattern layer of a scatterer (depolarizer).

A mixture including 3.9 mass % of calcium carbonate particles (Brillant 1500, manufactured by Shiraishi Calcium Kaisha, Ltd.), 14.6 mass % of an aliphatic polyurethane acrylate (CN985B 88 manufactured by Sartomer Japan Inc.) as a photopolymerizable oligomer, 9.7 mass % of isobornyl acrylate (LIGHT ACRYLATE IBXA, manufactured by Kyoeisha Chemical Co., Ltd.) and 58.2 mass % of 1,4-butanediol diacrylate (SR213, manufactured by Sartomer Japan Inc.) as a photopolymerizable monomer, 4.9 mass % of hydroxyhexylphenylethyl ketone (IRGACURE 184, manufactured by BASF Japan Ltd.) and 2.9 mass % of phenylbis(2,4,6-trimethylbenzoyl) phosphine oxide (IRGACURE 819, manufactured by BASF Japan Ltd.) as a photopolymerization initiator, and 0.1 mass % of 4,4′0[1,10-dioxo-1,10-decanediyl] bis(oxy)bis[2,2,6,6,-tetramethyl]-1-piperidinyloxy (IRGASTAB UV10 manufactured by BASF Japan Ltd.), and 1.8 mass % of an organic polymer (SOLSPERSE 36000, manufactured by The Lubrizol Corporation) as a dispersing agent were treated by a beads mill disperser, to disperse a pigment. Impurities were removed from the mixture after the dispersion by filtration to obtain an ultraviolet curable-type-ink jet ink.

In the same manufacturing process as in Example 3, a light guide member using the polarization conversion layer of the light transmission control layer as the pattern layer of the scatterer was manufactured by using this ultraviolet curable-type-ink jet ink instead of the λ/2 pattern liquid crystal ink of Example 3.

### [Example 6]

In the light guide member of Example 5, the first and second reflective polarizer layers of the light transmission control layer were changed in the same manner as in Example 2.

### Example 7

In the light guide member of Example 3, the overcoat layer of the light transmission control layer was changed to a low refractive index overcoat layer described below.

<Forming of Low Refractive Index Overcoat Layer>

The following components were mixed, propylene glycol monomethyl ether acetate was added so as to be 30 mass % in the total solvent, and dilution was performed with methyl ethyl ketone such that the concentration of the solid content finally became 5 mass % by mass, so as to prepare a solution.

The prepared solution was introduced to a glass separable flask equipped with a stirrer, stirred at room temperature for one hour, and then filtered through a polypropylene depth filter having a pore size of 0.5 μtm so as to prepare a composition.

Components of Composition (Part by Mass)

| | |
|---|---|
| A mixture of dipentaerythritol pentaacrylate and | 48.5 |
| dipentaerythritol hexaacrylate | |
| (manufactured by Nippon Kayaku Co., Ltd.) | |
| The following dispersion liquid A | 45 |
| Photopolymerization initiator (IRGACURE127, | 3 |
| manufactured by BASF SE) | |
| Antifouling agent (reactive silicone, manufactured | 3.5 |
| by Shin-Etsu Chemical Co., Ltd.) | |

Dispersion Liquid A

The conditions were adjusted by using the same method as in a dispersion liquid A-1 disclosed in JP2007-298974A, to prepare a hollow silica particle dispersion liquid (concentration of solid contents: 18.2% by mass) having an average particle diameter of 60 nm, a shell thickness of 10 nm, and a silica particle refractive index of 1.31.

15 parts by mass of acryloyloxypropyl trimethoxysilane and 1.5 parts by mass of diisopropoxy aluminum ethyl acetate were added to and mixed with 500 parts by mass of the hollow silica dispersion liquid, and then 9 parts by mass of ion exchange water was added thereto. After the reaction at 60° C. for eight hours, the resultant was cooled to room temperature, and 1.8 parts by mass of acetylacetone was added. The solvent was replaced by distillation under reduced pressure while methyl isobutyl ketone was added such that the total liquid amount became almost constant. Finally, the solid content was adjusted to 20% to prepare Dispersion Liquid A.

The prepared low refractive index coating liquid for overcoating was applied from a portion above the liquid crystal dots using a bar coater at a coating amount of 40 mL/m² and was applied so as to completely cover the liquid crystal dots. Thereafter, irradiation with ultraviolet rays of 500 mJ/cm² was performed by an ultraviolet irradiation device for reaction, so as to form an overcoat layer. The average refractive index of the liquid crystal dots was 1.58, and the refractive index of the overcoat layer was 1.4. The subsequent process of manufacturing the light guide member was the same as in the third example.

In this manner, since the liquid crystal dot portion can be caused to function as a convex lens by causing the refractive index of the spherical liquid crystal dots to be higher than that of the overcoat layer, light incident from a lower portion of a liquid crystal dot portion (the light guide layer side) was converged and deflected to an angle close to the normal direction of the light transmission control layer, so as to increase the light extraction efficiency.

### Example 8

In the light guide member of Example 7, the first and second reflective polarizer layers of the light transmission control layer were changed in the same manner as in Example 2.

[Evaluation Method]

For each of Comparative Example 1 and Examples 1 to 8, the front brightness of the flat light guide member and the front brightness of the light guide member having the 90° folded portion were compared. The front brightness was obtained by causing light to be incident on the end face of the light guide member 10 as illustrated in FIG. 5 (an example of a 90° folded light guide member) and measuring the brightness in the normal N direction of the surface at the center position of the light guide member by using BM-5A manufactured by Topcon Corporation.

The above evaluation results are presented in Table 2.

TABLE 2

| | | | Comparative | | | | |
|---|---|---|---|---|---|---|---|
| | | | example 1 | Example 1 | Example 2 | Example 3 | Example 4 |
| Structure | Configuration of reflective polarizer layer | | None | Cholesteric | APF | Cholesteric | APF |
| | Configuration of polarization conversion material | | None | Birefringence | Birefringence | Liquid crystal | Liquid crystal |
| | | | | layer | layer | dot | dot |
| | Additional configuration | | None | None | None | None | None |
| Effect | Front brightness | Preferable result | A | | | | |
| | maintenance ratio in case | Measurement result | D | A | A | A | A |
| | where light guide plate is bent | | | | | | |

| | | | Example 5 | Example 6 | Example 7 | Example 8 |
|---|---|---|---|---|---|---|
| Structure | Configuration of reflective polarizer layer | | Cholesteric | APF | Cholesteric | APF |
| | Configuration of polarization conversion material | | Scatterer | Scatterer | Liquid crystal | Liquid crystal |
| | | | | | dot | dot |
| | Additional configuration | | None | None | Light | Light |
| | | | | | condensing | condensing |
| | | | | | effect | effect |
| Effect | Front brightness | Preferable result | A | | | |
| | maintenance ratio in case | Measurement result | B | B | A | A |
| | where light guide plate is bent | | | | | |

<Evaluation Standard>

The ratio (front brightness maintenance ratio) of the front brightness of the light guide member having the 90° folded portion to the front brightness of the flat light guide member was as follows.

A: 100% to 80%

B: Less than 80% and 70% or more

C: Less than 70% and 60% or more

D: Less than 60%

In this evaluation, it is preferable that the front brightness did not decrease in a state in which the light guide member was bent by 90°, that is, A is the most satisfactory.

As presented in Table 2, in the light guide plate in the related art (Comparative Example 1) not having a light transmission control layer, the evaluation of the front brightness maintenance ratio was D, and in the state where the light guide member was bent by 90°, the front brightness greatly decreased. However, in the light guide members (Examples 1 to 8) according to the embodiment of the present invention, the evaluation of the front brightness maintenance ratio was B or more, and it was found that the decrease in the front brightness maintenance ratio was smaller than the light guide plate in the related art.

Further, in Examples 1 to 4, 7, and 8 in which a birefringent body was used as a polarization conversion material, the decrease in front brightness was less than in Examples 5 and 6 in which a depolarizer was used as a polarization conversion material, and thus it was found that the birefringent body is more preferable as the polarization conversion material.

It was also found that there was no significant difference between the birefringent polymer multilayer polarization film and the cholesteric liquid crystal for the reflective polarizer layer.

Even in a case where the light guide member manufactured in a flat state is bent after being manufactured, the same effect as the light guide member manufactured in the bent state as described above can be obtained.

From the above, the effect of the present invention is obvious.

### Example 10

First, a light transmission control layer 20-1 was manufactured.

In an irradiation portion of 40 mJ/cm² in a case where a birefringent pattern was manufactured, circles having a diameter d of 0.5 mm were provided at the pitch p of 1.0 mm in the pattern of FIG. 8. Except for this, the light guide member 10 was manufactured in the same manner as in Example 1.

### Example 11

As the light transmission control layer, the light transmission control layer 20-1 manufactured in Example 10 was used.

<<Manufacturing of In-Plane Brightness Homogenizing Layer>>

<Composition for Polymerization>

As a solid content, a photocurable acrylic resin, a photopolymerization initiator, a lubricant, and an additive were mixed and prepared as described below.

Components of Composition (Part by Mass)

| | |
|---|---|
| Acrylic resin A (pentaerythritol triacrylate/HDI | 30 |
| norate form, DESMODUR N3300, manufactured | |
| by Sumika Bayer Urethane Co., Ltd. (“HDI” means | |
| hexamethylene diisocyanate)) | |
| Acrylic resin B (polyethylene glycol diacrylate) | 20 |
| 50 parts by mass of an acrylic resin C (1,4-butanediol | 5 |
| diacrylate, SR213, manufactured by Sartomer), and a | |
| photopolymerization initiator (1-hydroxycyclohexyl | |
| phenyl ketone, IRGACURE 184, manufactured by | |
| Ciba Specialty Chemicals Inc.) | |
| 0.6 parts by mass of a lubricant (perfluoroalkyl ethylene | 0.3 |
| oxide adduct, MEGAFACE F443, manufactured by | |
| DIC Corporation) and a modified silicone oil (KF-353, | |
| manufactured by Shin-Etsu Chemical Co., Ltd.) | |
| Additive (hindered amine-based light stabilizer, | 0.6 |
| TINUVIN 765, manufactured by Ciba Japan K.K.) | |

<Forming of In-Plane Brightness Homogenizing Layer>

A die was prepared in the pattern of FIG. 8 in which conical projections having a diameter d of 0.5 mm and a height of 0.5 mm were provided at a pitch p of 1.0 mm. A predetermined amount of the aforementioned composition was applied to the surface of the die, and a polyethylene terephthalate film having a thickness of 100 μm was bonded thereto, and then the bonded laminate was pressure-bonded with a roller. The pressure was adjusted such that the thickness of the composition for polymerization became 0.75 mm. It was confirmed that a composition was evenly applied to the entire die, irradiation with ultraviolet rays was performed from the film side with energy of 2,000 mJ/cm² so as to photocure the ultraviolet curable resin composition. Thereafter, the cured product was peeled off from the die so as to obtain an in-plane brightness homogenizing layer 50-1 with a conical concave. The thickness of the polymerizable composition refers to a thickness in a case where the concave of the reflective portion 50a is flattened and refers to the thickness of the portion overlapped with the non-polarization conversion portion 22b in a case where the reflecting portion 50a was maintained in a concave shape.

<Lamination With Light Transmission Control Layer>

The alignment was performed such that the center of the polarization conversion portion 22a of the light transmission control layer 20-1 and the center of the reflecting portion 50a of the conical concave of the in-plane brightness homogenizing layer 50-1 overlap with each other, and the layers were bonded by using SK2057 manufactured by Soken Chemical & Engineering Co., Ltd., so as to obtain the light guide member 10-1.

### Example 12

After the in-plane brightness homogenizing layer 50-1 was manufactured in the same manner as in Example 11, a mask formed of stainless steel (SUS) having holes with the same position and diameter as the reflecting portion 50a of the in-plane brightness homogenizing layer 50-1 was prepared, and the in-plane brightness homogenizing layer 50-1 and the hole portion of the mask were overlapped so as to be aligned with each other. In this state, a thin film of Al was vapor-deposited from the mask surface side, so as to obtain an in-plane brightness homogenizing layer 50-2 in which a semi-transmissive reflection film of Al was formed in a concave portion of the reflecting portion 50a in a thickness such that the transmittance to the surface of the thin film was 5% and the reflectance was 75%. The in-plane brightness homogenizing layer 50-2 and the light transmission control layer 20-1 were bonded in the same manner as in Example 10 so as to obtain a light guide member 10-2.

### Examples 13, 14, and 17

In the same manner as in Example 11, the light guide members 10-3 and 10-4 and the light guide member 10-7 in which the size of the reflecting portion 50a was adjusted as presented in Table 3 were obtained.

### Example 15

Manufacturing was performed in the same manner as in Example 1 except that the irradiation portion of 40 mJ/cm² was caused to have the pitch p of 1.0 mm of squares of 0.5 mm squares in a case where a birefringent pattern was manufactured in the manufacturing process of the light transmission control layer 20-1.

In the forming of the in-plane brightness homogenizing layer, a light guide member 10-5 was obtained in the same manner as in Example 11, except that a die in which quadrangular pyramidal projections in a square of 0.5 mm squares and a height of 0.5 mm were arranged at the pitch p of 1.0 mm was prepared.

### Examples 16 and 18

Light guide members 10-6 and 10-8 were obtained in the same manner as in Example 11 except that the width of the reflecting portion 50a was changed as presented in Table 3.

### Example 19

In the forming of the in-plane brightness homogenizing layer of Example 10, a composition was applied on a smooth die having no shape to obtain a smooth resin film. A diffuse reflection film 50d having a thickness of 0.2 mm in a circular shape with a diameter of 0.5 mm was laminated on the resin film, by using a white diffuse reflective coating agent manufactured by Edmund Optics Inc. so as to manufacture a reflecting portion 50a. The transmittance of the diffusion reflection film was 5%, and the reflectance was 95%. In the same manner as in Example 11, the diffusion reflection film was bonded to the light transmission control portion so as to obtain a light guide member 10-9.

### Example 20

In the same manner as in Example 12, the size of the reflecting portion 50a was adjusted as presented in Table 3, so as to obtain a light guide member 10-10.

### Example 21

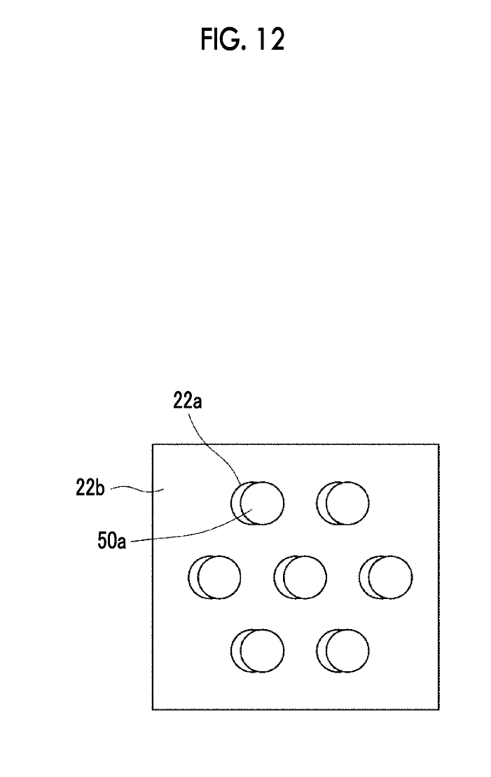

In the same manner as in Example 12, the in-plane brightness homogenizing layer 50-2 and the light transmission control layer 20-1 were prepared, and a light guide member 10-11 in which the central position of the polarization conversion portion 22a and the central position of the reflecting portion 50a of the in-plane brightness homogenizing layer 50-1 were deviated as presented in FIG. 12 and Table 3 was obtained.

[Evaluation Method]

Light was incident from the end faces of the light guide members 10 and 10-1 to 10-11, and the front brightness distribution of an area having 5 cm squares was measured by using an imaging color brightness meter PM-1400 manufactured by Radinat Vision Systems, LLC. The average brightness, the maximum brightness, and the minimum brightness of the region were obtained, so as to calculate the brightness change rate from the following equation below.

Brightness change rate=(maximum brightness−minimum brightness)/average brightness

Evaluation was performed in the following four stages with the brightness change rate as an index.

<Evaluation Sandard>

A: A brightness change rate was 0 or more and less than 20%

B: A brightness change rate was 20% or more and less than 40%

C: A brightness change rate was 40% or more and less than 60%

D: A brightness change rate was 60% or more

TABLE 3

| | | Exam- | Exam- | Exam- | Exam- | Exam- | Exam- |
|---|---|---|---|---|---|---|---|
| | Unit | ple 10 | ple 11 | ple 12 | ple 13 | ple 14 | ple 15 |
| Diameter of polarization | mm | 0.50 | 0.50 | 0.50 | 0.20 | 0.80 | 0.50 |
| conversion portion | | | | | | | |
| Pitch of polarization | mm | 1.00 | 1.00 | 1.00 | 0.40 | 1.60 | 1.00 |
| conversion portion | | | | | | | |
| Existence/non-existence | | None | Exist | Exist | Exist | Exist | Exist |
| of in-plane brightness | | | | | | | |
| homogenizing layer | | | | | | | |
| Shape of reflecting | | — | Conical | Conical | Conical | Conical | Quadrangular |
| portion | | | concave | concave + | concave + | concave + | concave + |
| | | | | Al semi- | Al semi- | Al semi- | Al semi- |
| | | | | transmissive | transmissive | transmissive | transmissive |
| | | | | reflection | reflection | reflection | reflection |
| | | | | film | film | film | film |
| Width of reflecting | mm | — | 0.50 | 0.50 | 0.25 | 0.80 | 0.50 |
| portion | | | | | | | |
| Height of reflecting | mm | — | 0.50 | 0.50 | 0.25 | 0.80 | 0.50 |
| portion | | | | | | | |
| Pitch of reflecting | mm | — | 1.00 | 1.00 | 0.50 | 1.60 | 1.00 |
| portion | | | | | | | |
| Thickness of in-plane | mm | — | 0.75 | 0.75 | 0.50 | 1.05 | 0.75 |
| brightness homogenizing | | | | | | | |
| layer | | | | | | | |
| Deviation of center of | mm | — | 0.00 | 0.00 | 0.00 | 0.00 | 0.00 |
| polarization conversion | | | | | | | |
| portion and center of | | | | | | | |
| reflecting member | | | | | | | |
| Brightness distribution | | D | B | A | A | B | A |

| | | Exam- | Exam- | Exam- | Exam- | Exam- | Exam- |
|---|---|---|---|---|---|---|---|
| | Unit | ple 16 | ple 17 | ple 18 | ple 19 | ple 20 | ple 21 |
| Diameter of polarization | mm | 0.50 | 2.00 | 0.50 | 0.50 | 0.50 | 0.50 |
| conversion portion | | | | | | | |
| Pitch of polarization | mm | 1.00 | 4.00 | 1.00 | 1.00 | 1.00 | 1.00 |
| conversion portion | | | | | | | |
| Existence/non-existence | | Exist | Exist | Exist | Exist | Exist | Exist |
| of in-plane brightness | | | | | | | |
| homogenizing layer | | | | | | | |
| Shape of reflecting | | Conical | Conical | Conical | Diffuse | Conical | Conical |
| portion | | concave + | concave + | concave + | reflective | concave + | concave + |
| | | Al semi- | Al semi- | Al semi- | film layer | Al semi- | Al semi- |
| | | transmissive | transmissive | transmissive | | transmissive | transmissive |
| | | reflection | reflection | reflection | | reflection | reflection |
| | | film | film | film | | film | film |
| Width of reflecting | mm | 0.58 | 2.00 | 0.65 | 0.50 | 0.45 | 0.50 |
| portion | | | | | | | |
| Height of reflecting | mm | 0.58 | 2.00 | 0.65 | 0.20 | 0.45 | 0.20 |
| portion | | | | | | | |
| Pitch of reflecting | mm | 1.00 | 4.00 | 1.00 | 1.00 | 1.00 | 1.00 |
| portion | | | | | | | |
| Thickness of in-plane | mm | 0.75 | 2.25 | 0.75 | 0.75 | 0.75 | 0.75 |
| brightness homogenizing | | | | | | | |
| layer | | | | | | | |
| Deviation of center of | mm | 0.00 | 0.00 | 0.00 | 0.00 | 0.00 | 0.10 |
| polarization conversion | | | | | | | |
| portion and center of | | | | | | | |
| reflecting member | | | | | | | |
| Brightness distribution | | B | C | C | A | C | C |

As presented in Table 3 above, in the light guide member (Example 10) not having an in-plane brightness homogenizing layer, the evaluation of the brightness change rate was D and the rate of change of the front brightness distribution was large. However, in the light guide member (Example 11) provided with the in-plane brightness homogenizing layer, the evaluation was B, and it was understood that, by providing the in-plane brightness homogenizing layer, the change rate of the front brightness distribution was small, and the in-plane brightness was homogenized.

Although the light guide member (Example 11) in which the semi-transmissive reflection film 50c was not provided in the reflecting portion 50a was evaluated as B, it was understood that the light guide member (Example 12) provided with the semi-transmissive reflection film 50c in the reflecting portion 50a and the light guide member (Example 19) provided with the diffuse reflection film 50d were evaluated as A, and the in-plane brightness was further homogenized by the semi-transmissive reflection film 50c or the diffuse reflection film 50d.

Even in a case where both of the semi-transmissive reflection film 50c and the diffuse reflection film 50d were used, it was found that the in-plane brightness was further homogenized in the same degree.

The evaluation of the light guide member (Example 17) in which the diameter and the pitch of the polarization conversion portions 22a were greater than 1 mm was C, but the evaluations of the light guide members (Examples 12 to 14) in which the diameter and the pitch of the polarization conversion portions 22a were 1 mm or less were A or B, and thus it was found that as the diameter and the pitch of the polarization conversion portion 22a were smaller, the brightness became homogenized.

The light guide member (Example 12) in which the size ratio of the width of the reflecting portion 50a and the diameter of the polarization conversion portion 22a was 1.0 time was evaluated as A, the light guide member (Example 16) in which the size ratio was 1.15 times was evaluated as B, the light guide member (Example 18) in which the size ratio was 1.3 times was evaluated as C, and it was found that the size ratio of 1.0 time was most preferable, and the size ratio of 1.3 times to 1.15 times was satisfactory.

Even in a case where the shape of the reflecting portion 50a was a conical shape (Example 12) or a quadrangular pyramidal shape (Example 15), all evaluations were A, and it was found that the shape was satisfactory as long as the reflecting portion 50a can be isotropically reflected.

The light guide member (Example 20) having the size ratio of 0.9 times was evaluated as C, and the light guide member (Example 11) having the size ratio of 1 time was evaluated as A, the light guide member (Example 16) having the size ratio of 1.15 times was evaluated as B, and the light guide member (Example 18) having the size ratio of 1.3 times was evaluated as C. From this, it was found that the in-plane brightness of the light guide member was homogenized by manufacturing the light guide member in the range in which the size ratio was 1.0 or more and less than 1.2.

Further, the light guide member (Example 21) in which the center of the polarization conversion portion 22a and the center of the reflecting portion 50a were deviated was evaluated as C, the light guide member (Example 12) in which the center of the polarization conversion portion 22a and the center of the reflecting portion 50a were aligned was evaluated as A, and the in-plane brightness was homogenized by aligning the center of the polarization conversion portion 22a and the center of the reflecting portion 50a.

In Examples 10 to 19, the light guide members were evaluated, but it is obvious that the in-plane brightness was homogenized in the same manner as in the backlight using this light guide member.

### EXPLANATION OF REFERENCES

1, 1a: liquid crystal display device

10, 10a: light guide member

12: back surface side reflection plate

14: light source

16: light guide plate

16a: end face of light guide plate

16b: first main surface of light guide plate

16c: second main surface of light guide plate

20, 30: light transmission control layer

21, 31: reflective polarizer layer

22, 32: polarization conversion layer

22a, 32a: polarization conversion portion

22b, 32b: non-polarization conversion portion

23, 33: reflective polarizer layer

40: liquid crystal display element

50: in-plane brightness homogenizing layer

50a: reflecting portion

50b: light guide portion

50c: semi-transmissive reflection film

50d: diffuse reflection film

60: iron rod

L1, L2, L3: light

L_{L}: left-handed circularly polarized light

L_{O}: Other polarized light

L_{R}: right-handed circularly polarized light

N: normal direction

What is claimed is:

1. Alight guide member comprising:
a light guide layer that guides incident light and emits the light from at least one main surface; and
a light transmission control layer that is integrally laminated on the light guide layer on a main surface side of the light guide layer that emits the light and controls a region that transmits the light,
wherein the light transmission control layer has a polarization conversion layer in which a polarization conversion material is patterned, between two reflective polarizer layers having different reflection polarization directions.

2. The light guide member according to claim 1,
wherein the polarization conversion material is a birefringent body.

3. The light guide member according to claim 1,
wherein the polarization conversion material is a depolarizer.

4. The light guide member according to claim 1,
wherein the reflective polarizer layer is a birefringent polymer multilayer polarization film.

5. The light guide member according to claim 1,
wherein the reflective polarizer layer is a cholesteric liquid crystal.

6. A backlight unit comprising:
a light guide member provided with an in-plane brightness homogenizing layer on the light transmission control layer of the light guide member according to claim 1; and
a light source that causes light to be incident on the light guide member.

7. A liquid crystal display device comprising:
a liquid crystal display element in which backlight is incident from a backlight incidence surface on an opposite side to an image display surface; and
a backlight unit having the light guide member according to claim 1 and a light source that causes light to be incident on the light guide member,
wherein the liquid crystal display element and the light guide member are integrally laminated on each other, in a state in which the backlight incidence surface of the liquid crystal display element and the light transmission control layer of the light guide member face each other, and a polarization axis direction in a case of incidence of backlight set in the liquid crystal display element and a polarization axis direction of light emitted from the light guide member coincide with each other.

8. A liquid crystal display device comprising:
a liquid crystal display element in which backlight is incident from a backlight incidence surface on an opposite side to an image display surface; and
the backlight unit according to claim 6,
wherein the liquid crystal display element and the light guide member are integrally laminated on each other, in a state in which the backlight incidence surface of the liquid crystal display element and the light transmission control layer of the light guide member face each other, and a polarization axis direction in a case of incidence of backlight set in the liquid crystal display element and a polarization axis direction of light emitted from the light guide member coincide with each other.
